(19) United States
(12) Patent Application Publication
(10) Pub. No.: US 2011/0103309 A1
(43) Pub. Date: May 5, 2011

(54) METHOD AND APPARATUS FOR CONCURRENTLY PROCESSING MULTIPLE RADIO CARRIERS

(75) Inventors: Lei Wang, San Diego, CA (US); Ronald G. Murias, Calgary (CA)

(73) Assignee: INTERDIGITAL PATENT HOLDINGS, INC., Wilmington, DE (US)

(21) Appl. No.: 12/915,693

(22) Filed: Oct. 29, 2010

Related U.S. Application Data
(60) Provisional application No. 61/256,481, filed on Oct. 30, 2009.

(51) Int. Cl. H04W 40/00

(52) U.S. Cl. 370/328

(57) ABSTRACT

A concurrent multi-carrier (MC) wireless transmit/receive unit (WTRU) capable of concurrently processing multiple radio carriers may simultaneously connect to multiple base stations for receiving multiple service flows via multiple air links. The concurrent-MC WTRU may be serviced by multiple base stations through multiple concurrent radio carriers simultaneously during normal operation for downlink and/or uplink communications. Each base station may provide special services optimized for each base station. The WTRU may use a lower quality air link for low priority services or low resolution data services while use a higher quality air link for high bandwidth or low latency services. A diversity gain may be achieved by combining signals from multiple base stations. The support and use of the multiple air links at the WTRU may be transparent to the base stations. Alternatively, base stations' support may be provided for setting up and operations of the multiple air links.

### CROSS REFERENCE TO RELATED APPLICATIONS

This application claims the benefit of U.S. provisional application No. 61/256,481 filed Oct. 30, 2009, the contents of which is hereby incorporated by reference herein.

### BACKGROUND

In order to improve achievable throughput and coverage of wireless access systems, multi-carrier operations have been proposed. In the multi-carrier operations, a wireless transmit/receive unit (WTRU) may be configured with more than one radio carriers in the uplink (UL) and/or in the downlink (DL). The multi-carrier operations would allow UL and DL transmission bandwidths to exceed a single carrier frequency and allow for more flexible and more efficient usage of the available spectrums.

### SUMMARY

A concurrent multi-carrier (MC) wireless transmit/receive unit (WTRU) is capable of concurrently processing multiple radio carriers. The concurrent-MC WTRU may simultaneously connect to multiple base stations for receiving one or more service flows via multiple air links. The concurrent-MC WTRU may be serviced by multiple base stations through multiple concurrent radio carriers simultaneously during normal operation for downlink and/or uplink communications. Each base station may provide special services optimized for each base station. The WTRU may use a lower quality air link for low priority services or low resolution data services while using a higher quality air link for high bandwidth or low latency services. A diversity gain may also be achieved by combining the signals from the multiple base stations transmitting the same data. The support and use of the multiple air links at the WTRU may be transparent to the base stations. Alternatively, base stations' support may be provided for setting up and operations of the multiple air links. When a concurrent-MC WTRU is connected to multiple base stations through its concurrent multi-carriers, the WTRU may learn and maintain its knowledge about its multiple air links, including the air link quality, data rate, service offerings of the corresponding base stations, etc., and may use such knowledge to initiate and control the load balancing, service selection, etc.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 shows an example concurrent-MC WTRU in accordance with one embodiment;

FIG. 3 shows an example concurrent-MC WTRU in accordance with another embodiment;

FIG. 4 shows an example concurrent-MC WTRU in accordance with another embodiment;

FIG. 5 shows an example concurrent-MC WTRU in accordance with another embodiment;

FIG. 6 shows an example structure of a common MAC entity of the concurrent-MC WTRU in accordance with one embodiment;

FIG. 7 is a flow diagram of an example process of WTRU-initiated service flow creation in accordance with one embodiment;

FIG. 8 is a flow diagram of an example process of base station-initiated service flow creation in accordance with one embodiment; and

FIG. 9 is a flow diagram of an example process of service flow remapping in accordance with one embodiment.

### DETAILED DESCRIPTION

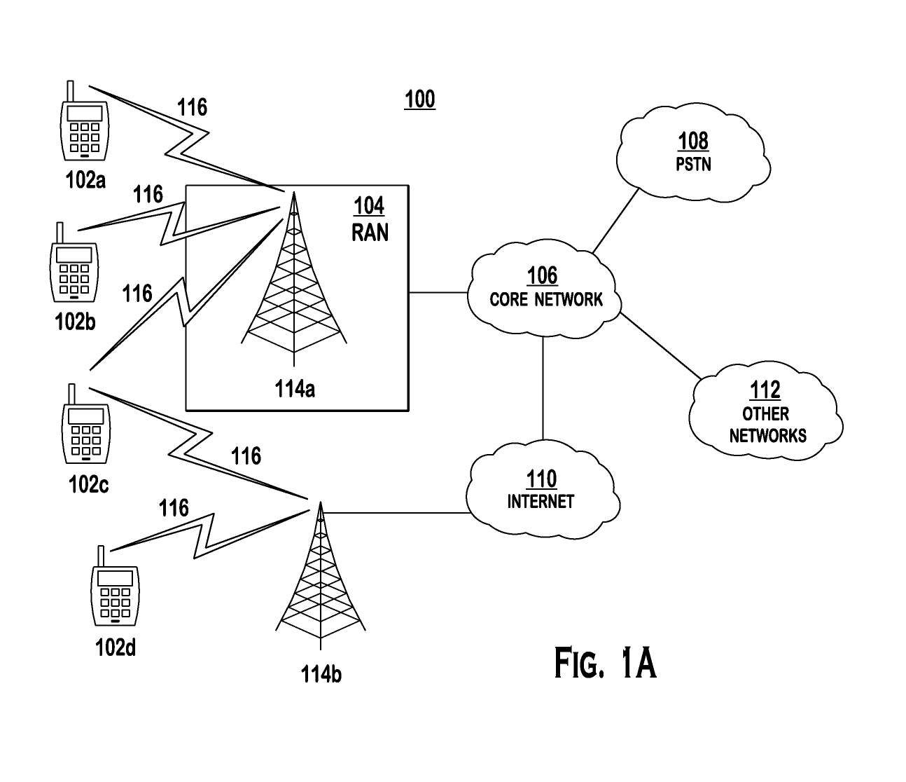

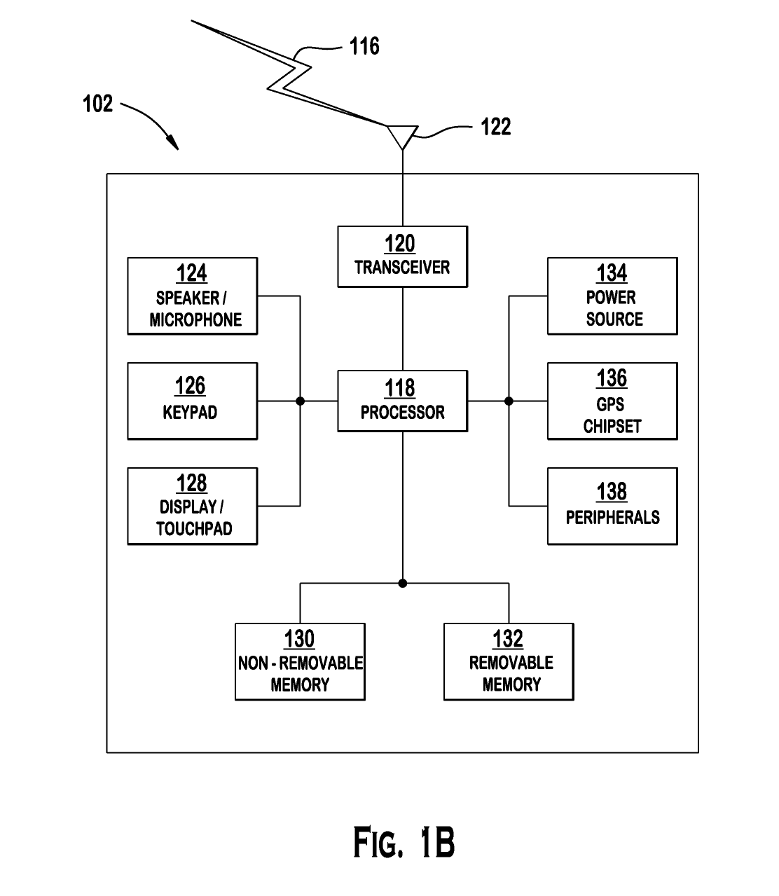

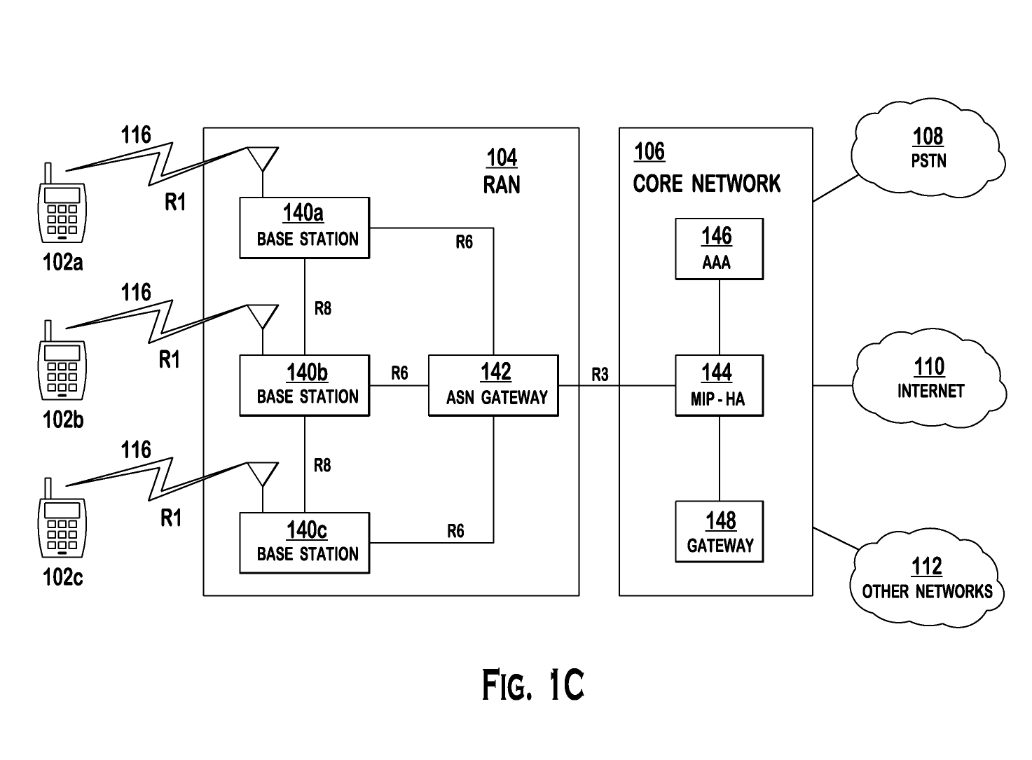

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1C, the RAN 104 may include base stations 140a, 140b, 140c, and an ASN gateway 142, though it will be appreciated that the RAN 104 may include any number of base stations and ASN gateways while remaining consistent with an embodiment. The base stations 140a, 140b, 140c may each be associated with a particular cell (not shown) in the RAN 104 and may each include one or more transceivers for communicating with the WTRUs 102a, 102b, 102c over the air interface 116. In one embodiment, the base stations 140a, 140b, 140c may implement MIMO technology. Thus, the base station 140a, for example, may use multiple antennas to transmit wireless signals to, and receive wireless signals from, the WTRU 102a. The base stations 140a, 140b, 140c may also provide mobility management functions, such as handoff triggering, tunnel establishment, radio resource management, traffic classification, quality of service (QoS) policy enforcement, and the like. The ASN gateway 142 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 140a, 140b, 140c may be defined as an R8 reference point that includes protocols for facilitating WTRU handovers and the transfer of data between base stations. The communication link between the base stations 140a, 140b, 140c and the ASN gateway 215 may be defined as an R6 reference point. The R6 reference point may include protocols for facilitating mobility management based on mobility events associated with each of the WTRUs 102a, 102b, 100c.

As shown in FIG. 1C, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 144, an authentication, authorization, accounting (AAA) server 146, and a gateway 148. While each of the foregoing elements are depicted as part of the core network 106, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 144 may provide the WTRUs 102a, 102b, 102c with access to packet-switched networks, such as the Internet 110, to facilitate communications between the WTRUs 102a, 102b, 102c and IP-enabled devices. The AAA server 146 may be responsible for user authentication and for supporting user services. The gateway 148 may facilitate interworking with other networks. For example, the gateway 148 may provide the WTRUs 102a, 102b, 102c with access to circuit-switched networks, such as the PSTN 108, to facilitate communications between the WTRUs 102a, 102b, 102c and traditional land-line communications devices. In addition, the gateway 148 may provide the WTRUs 102a, 102b, 102c with access to the networks 112, which may include other wired or wireless networks that are owned and/or operated by other service providers.

Although not shown in FIG. 1C, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

Herein the terminology “concurrent-MC WTRU” (or simply “WTRU”) will be referred to as a WTRU that is capable of concurrently processing multiple radio carriers. Concurrent-carriers are the radio carriers that may be concurrently processed by the concurrent-MC WTRU.

Herein, the terminology “air link” refers to a radio connection between a WTRU and a base station. For an MC-WTRU, an air link may comprise multiple radio carriers.

Herein, the terminology “air interface” refers to a wireless network interface that receives and transmits data or any type of information from and to the data communication applications running on a WTRU. For example, in the context of IEEE 802.16, an air interface comprises Layer-2 and Layer-1 and provides transportation services for the upper layers, (i.e., Layer-3 and up).

Herein, the terminology “serving air link” (or equivalently “serving base station”) refers to an air link (or a base station) to which a WTRU is connected for communication. A concurrent-MC WTRU may have multiple serving air links (i.e., serving base stations). Hereafter, the terminology “serving air link set” (or equivalently “serving base station set”) refers to a set of serving air links (or base stations) that a concurrent-MC WTRU is connected through its concurrent multi-carriers.

In accordance with one embodiment, a concurrent-MC WTRU may simultaneously connect to multiple base stations for receiving one or more service flows via multiple air links. When connected to the multiple base stations, the concurrent-MC WTRU may connect to each of the base stations through one or multiple radio carriers. The capability of the concurrent-MC WTRU may be utilized to improve system performance. For example, if a concurrent-MC WTRU is connected to multiple base stations simultaneously for communication, a handover may be optimized for seamless service flow migration.

A concurrent-MC WTRU may be serviced by multiple base stations through multiple concurrent radio carriers simultaneously during normal operation for downlink and/or uplink communications. Each base station may provide special services optimized for each base station. For example, the concurrent-MC WTRU may be connected to a macro-cell base station and a micro-cell base station, (e.g., a femto-cell base station, a pico-cell base station, a wireless hotspot access point, or the like), and receive a voice service via the macro-cell base station and a data service via the micro-cell base station.

With the embodiments disclosed herein, more flexibility or service choices for the concurrent-MC WTRU is possible. For example, the WTRU may use a lower quality air link for low priority services or low resolution data services while using a higher quality air link for high bandwidth or low latency services. A diversity gain may also be achieved by combining the signals from the multiple base stations transmitting the same data.

A concurrent-MC WTRU may use its multiple air links to maintain multiple simultaneous connections with base stations supporting different protocols. For example, the concurrent-MC WTRU may establish a connection with a legacy 802.16 base station on one air link while establishing a connection with 802.16m base station on the other air link.

When a concurrent-MC WTRU is connected to multiple base stations through its concurrent multi-carriers, the WTRU may learn and maintain its knowledge about its multiple air links, including the air link quality, data rate, service offerings of the corresponding base stations, etc. The WTRU may use such knowledge to initiate and control the load balancing, service selection, etc.

The multiple air links of the concurrent-MC WTRU may be managed and controlled by either a single common medium access control (MAC) entity or separate MAC entities. With separate MAC entities configured, multiple separate air-interfaces are provided to the upper layers, each with one base station. If a common MAC is configured, one air-interface is provided to the upper layers that may comprise multiple air links, each air link per base station. The multiple air links of the concurrent-MC WTRU may be supported by multiple physical layer (PHY) processing units and radio frequency (RF) units, one for each air link. Alternatively, the multiple air links may be supported by a single common PHY processing unit and multiple RF units. With a signal common PHY processing unit, the concurrent-MC WTRU may include separate fast Fourier transform/inverse fast Fourier transform (FFT/IFFT) units.

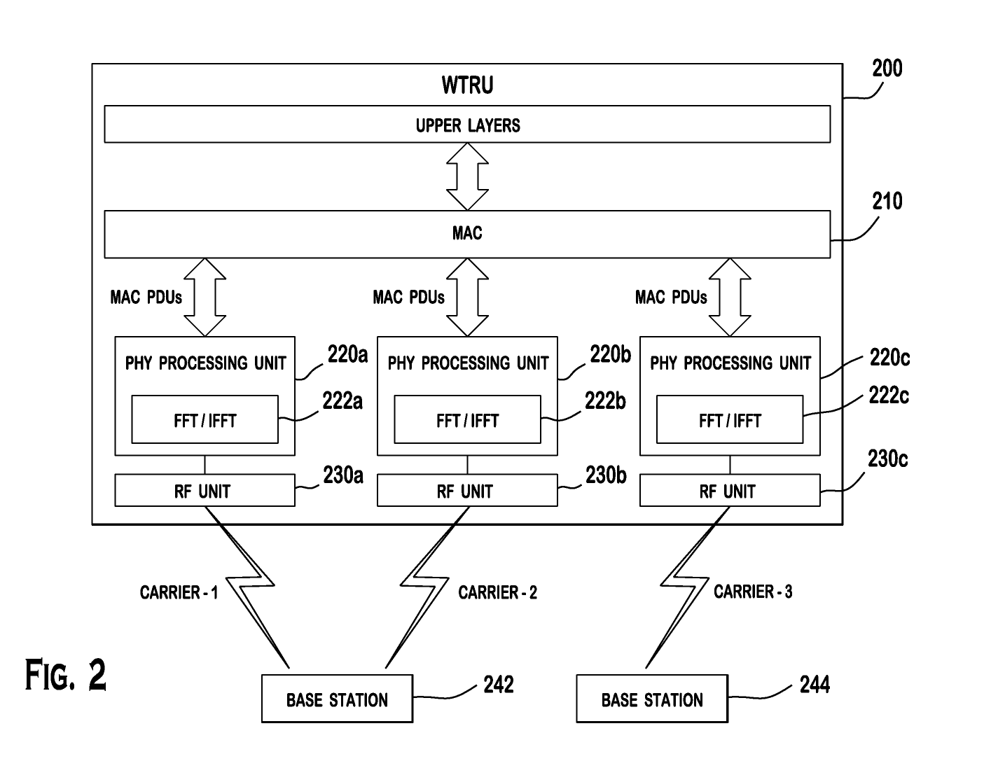

FIG. 2 shows an example concurrent-MC WTRU 200 in accordance with one embodiment. The WTRU 200 includes a common MAC entity 210, separate PHY processing units 220a-220c, and separate RF units 230a-230c. Each PHY processing unit 220a-220c includes an FFT/IFFT unit 222a-222c, respectively. The WTRU 200 may be configured with multiple (three (3) in this example) radio carriers with a separate PHY processing unit 220a-220c and a separate RF unit 230a-230c for each radio carrier. The concurrent-MC WTRU 200 is connected to two base stations 242, 244 in this example. The concurrent-MC WTRU 200 shown in FIG. 2 has one air interface that comprises two air links with the two base stations 242, 244. The air link to the base station 242 comprises two radio carriers and the air link to the base station 244 comprises one radio carrier.

It should be noted that the configuration of the WTRU shown in the drawings and description is provided as an example, not as a limitation, and the WTRU may comprise any number of processing units or entities and may be configured with any number of radio carriers for communication with any number of base stations.

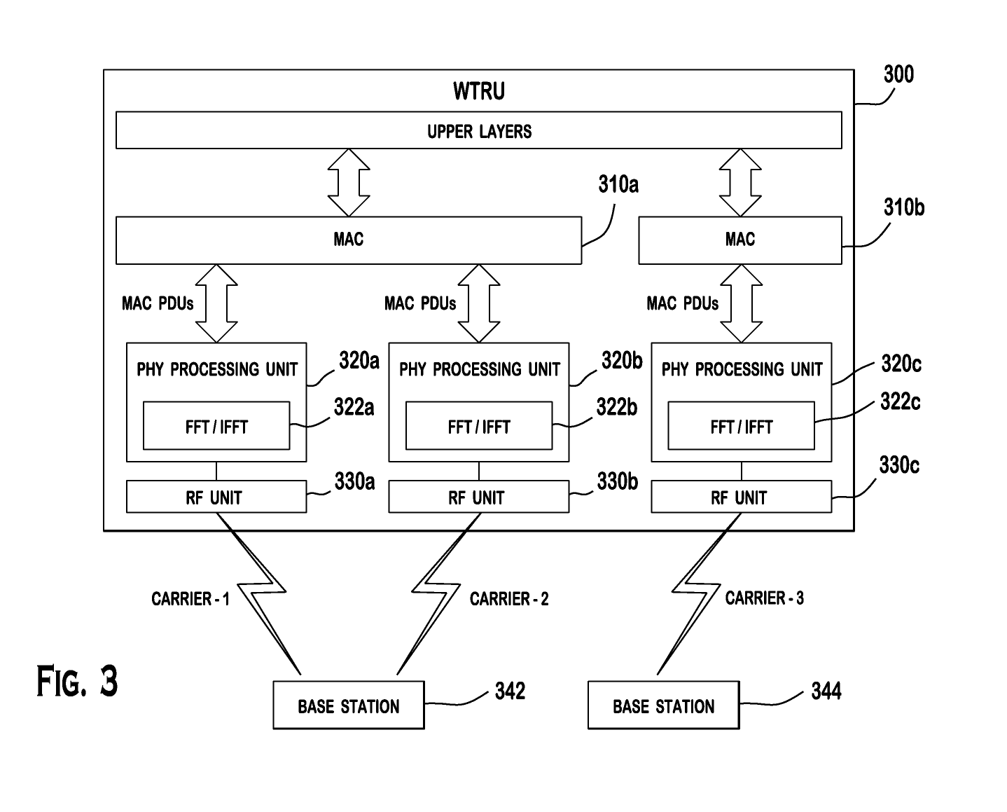

FIG. 3 shows an example concurrent-MC WTRU 300 in accordance with another embodiment. The WTRU 300 includes separate MAC entities 310a, 310b, separate PHY processing units 320a-320c, and separate RF units 330a-330c. Each PHY processing unit 320a-320c includes an FFT/IFFT unit 322a-322c, respectively. The WTRU 300 may be configured with multiple (three in this example) radio carriers with a separate PHY processing unit 320a-320c and a separate RF unit 330a-330c for each radio carrier. The WTRU 300 is connected to two base stations 342, 344 in this example. With separate MAC entities 310a, 310b for each air link of the concurrent-MC WTRU 300, each air link corresponds to an air interface. In FIG. 3, two air interfaces are configured for the WTRU 300.

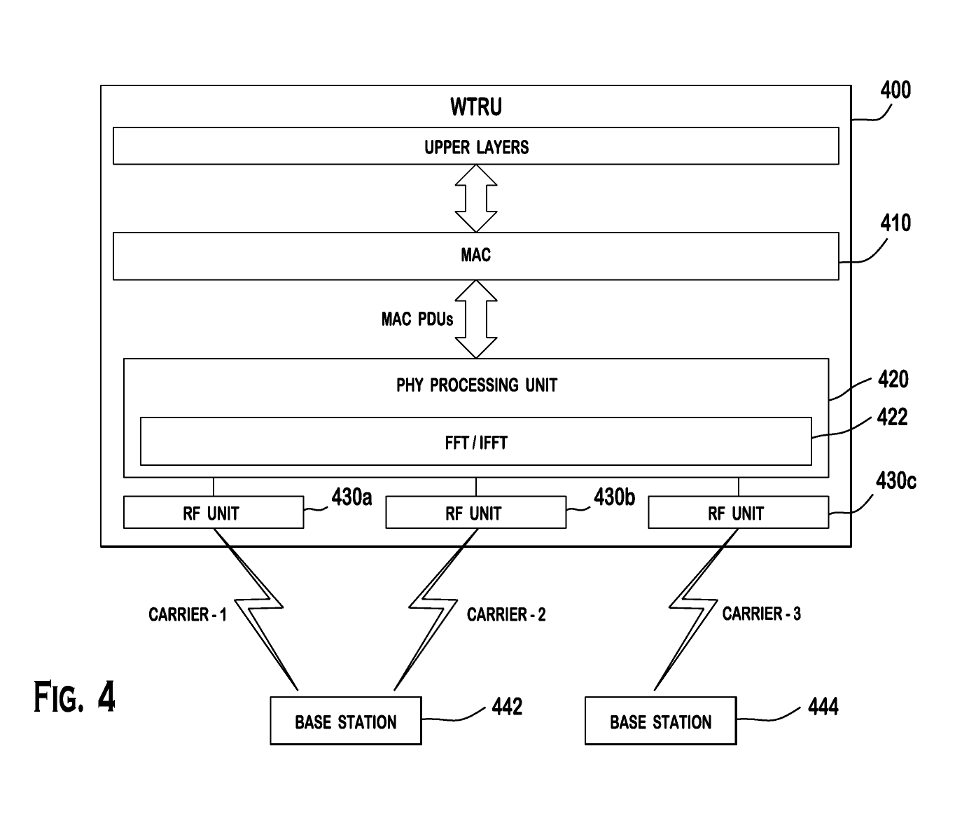

FIG. 4 shows an example concurrent-MC WTRU 400 in accordance with another embodiment. The WTRU 400 includes a common MAC entity 410, a common PHY processing unit 420 with a single FFT/IFFT processing unit 422, and separate RF units 430a-430c. The WTRU 400 may be configured with multiple (three in this example) radio carriers with a separate RF unit 430a-430c for each radio carrier. The WTRU 400 is connected to two base stations 442, 444 in this example. The common PHY processing unit 420 performs baseband processing for multiple air links. With a larger capacity baseband processor, (e.g., a larger FFT/IFFT unit 422), a larger number of carriers may be processed simultaneously by the single PHY processing unit 420. For example, the common MAC entity 410 and the common PHY processing unit 420 may allow two 10 MHz carriers to be processed by one 20 MHz baseband processor. This has an advantage of lower complexity and fewer PHY components. This configuration may also allow the PHY processing unit 420 to process identical or similar signals from two or more base stations and combine the signals on different carriers from multiple base stations for diversity gain. For transmission, the data for the carriers may be processed simultaneously, and the time domain data may then be passed on to the individual RF units for transmission.

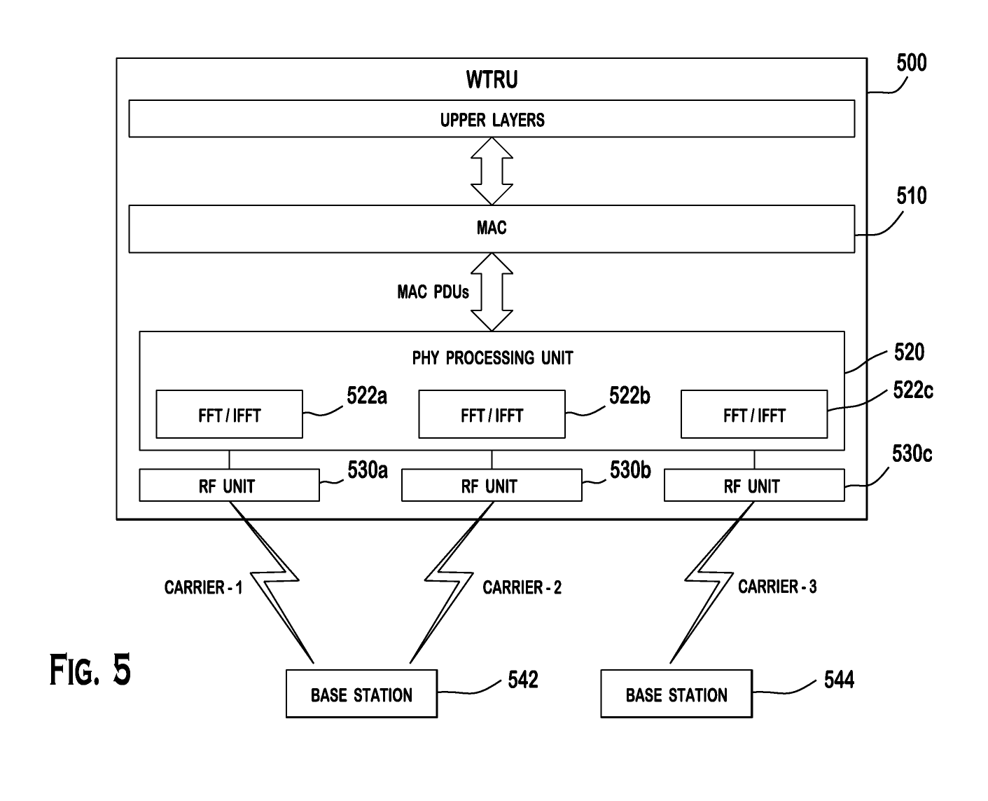

FIG. 5 shows an example concurrent-MC WTRU 500 in accordance with another embodiment. The WTRU 500 includes a common MAC entity 510, a common PHY processing unit 520 with separate FFT/IFFT processing units 522a-522c, and separate RF units 530a-530c. The common PHY processing unit 520 performs baseband processing for multiple air links. The WTRU 500 may be configured with multiple (three in this example) radio carriers with a separate RF unit 530a-530c for each radio carrier. The WTRU 500 is connected to two base stations 542, 544 in this example.

For receive processing, once the data has been transformed to the frequency domain by the FFT processing units 522a-522c, the PHY processing unit 520 may maintain separate channels to the MAC interface. Alternatively, where the same data is received from one or more base stations on different channels, the data may be combined by the PHY processing unit 520 to take advantage of the diversity before passing the data on to the MAC interface.

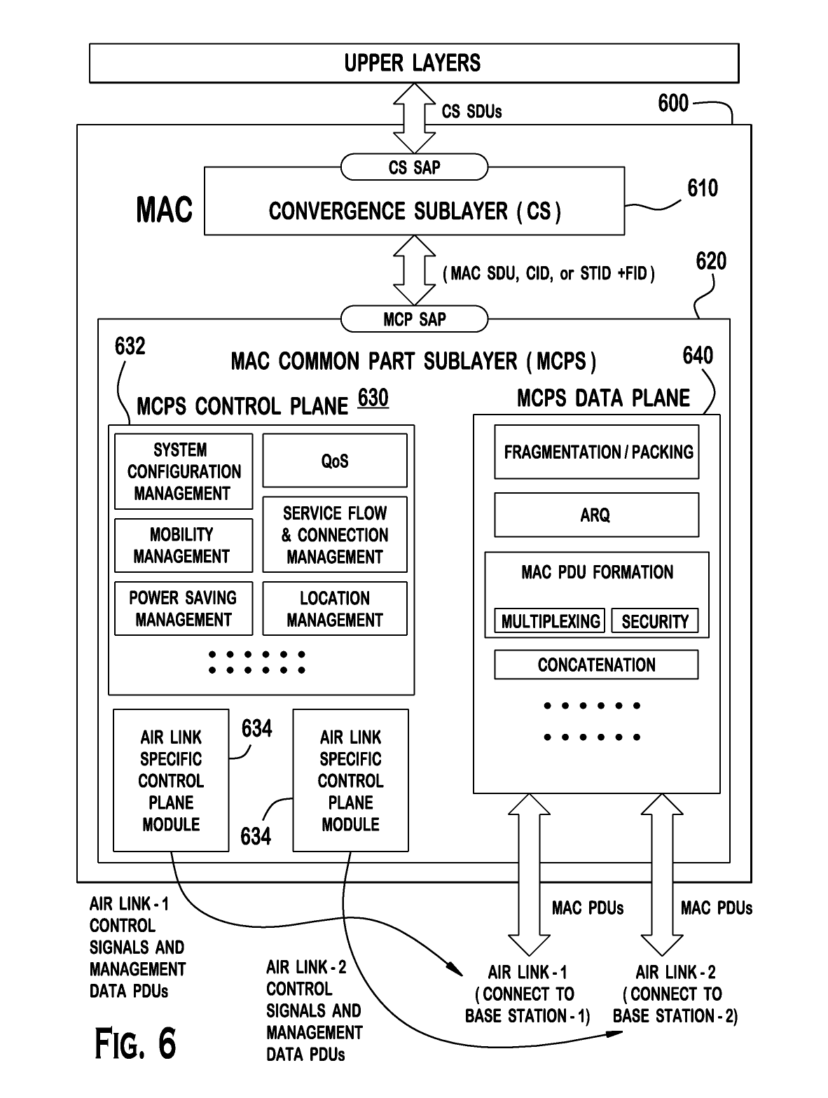

FIG. 6 shows an example structure of a common MAC entity 600 of the concurrent-MC WTRU in accordance with one embodiment. As an example, two air links are configured for the WTRU in FIG. 6. The common MAC entity 600 comprises a convergence sublayer 610 and a MAC common part sublayer 620. The MAC common part sublayer 620 comprises a control plane 630 and a data plane 640. The convergence sublayer 610 provides any transformation or mapping of external network data into MAC service data units (SDUs), which are received by the MAC common part sublayer 620 via a MAC service access point (SAP). The MAC common part sublayer 620 provides core MAC functionalities.

The common MAC entity 600 may provide the same interface to the upper layers as the conventional 802.16m MAC entity so that the upper layers of the concurrent-MC WTRU may remain unchanged. The provision of multiple air links through multiple concurrent carriers is transparent to the upper layers of the concurrent-MC WTRU, while all the intelligence and processing of multiple air links are kept in the common MAC entity 600 and lower layers. The convergence sublayer 610 and the data plane 640 of the MAC common part sublayer may perform the same functions as the conventional 802.16m MAC entity. The data mapping to the multiple air links for the concurrent-MC WTRU data may be done through the service flow mapping to the multiple air links which will be described in detail below.

The control plane 630 of the MAC common part sublayer comprises two types of function modules: non-air-link-specific function modules 632 and air-link-specific function modules 634. The non-air-link-specific function modules 632 control and manage all the air links of the concurrent-MC WTRU including, but not limited to, system configuration management, quality of service (QoS) control, mobility management, service flow and connection management, power saving management, location management, and the like.

The air-link-specific function modules 634 perform a network entry procedure, ranging, link adaptation, control signaling, and the like. The air-link-specific function module 634 may have multiple instances, each per air link. With the air-link-specific function modules 634, the multiple air links of the concurrent-MC WTRU may be controlled and managed independently. For example, each air link may have its own downlink and uplink control channel(s), a resource allocation mechanism(s), a control and management connection(s), etc. The concurrent-MC WTRU may have a different station identity (STID) assigned to each of the multiple air links by the corresponding base station.

The concurrent-MC WTRU may perform the network entry procedure with each air link separately, such that the same network entry procedure as defined for one air link may be repeatedly performed. Alternatively, once the network entry procedure is complete for one air link, some step(s) of the network entry procedure, (e.g., security checking), may be omitted for the remaining air links.

The concurrent-MC WTRU may maintain its multiple air links through the periodic ranging process separately on each air link. The power saving mechanisms, (e.g., sleep mode, idle mode, etc.), may be supported by the concurrent-MC WTRU using either the same procedures as defined for a single air link applied on each of its multiple air links, or a different procedure due to the availability of multiple air links. For example, location updates may be skipped because of the availability of another active air link. During the idle state, a WTRU performs a location update and periodically wakes up to listen to the network for paging messages. When a concurrent-MC WTRU has multiple air links, and one of them goes to idle while at least one of other air links is still active, the concurrent-MC WTRU may not perform a location update or paging message processing on the idle air link, as it is still actually connected to the network through another air link.

When a concurrent-MC WTRU is connected to multiple base stations through its concurrent multiple carriers, the service flows of the WTRU may be mapped to the air links with multiple base stations in a static or semi-static manner. A service flow may be mapped to one air link and one air link may accommodate multiple service flows. The mapping between the service flow and the air link is initially established at service flow initialization. The service flow initialization may be initiated by the WTRU or by the base station.

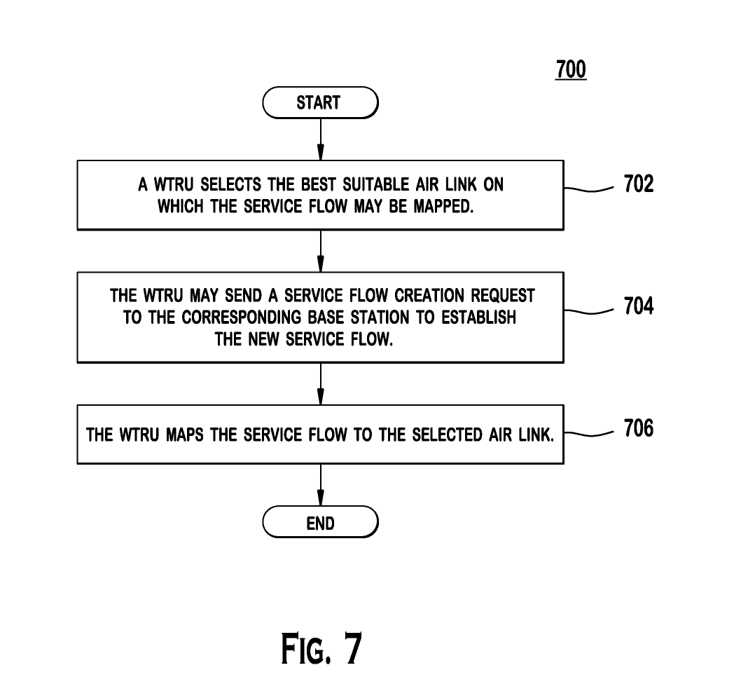

FIG. 7 is a flow diagram of an example process 700 of WTRU-initiated service flow creation in accordance with one embodiment. In the case of WTRU-initiated service flow, the mapping of a newly created service flow to one of its concurrent air links is determined by the WTRU. The WTRU selects the best suitable air link on which the service flow may be mapped (702). The best suitable air link may be selected based on the service flow attributes, (e.g., quality of service (QoS) requirements, traffic characteristics, etc.), and/or the air link attributes, (e.g., the air link quality, the air link service offerings, air link loadings, etc.). After the best suitable air link selection is done, the concurrent-MC WTRU may send a service flow creation request to the corresponding base station to establish the new service flow (704). Once the service flow is established, the WTRU maps the service flow to the selected air link (706).

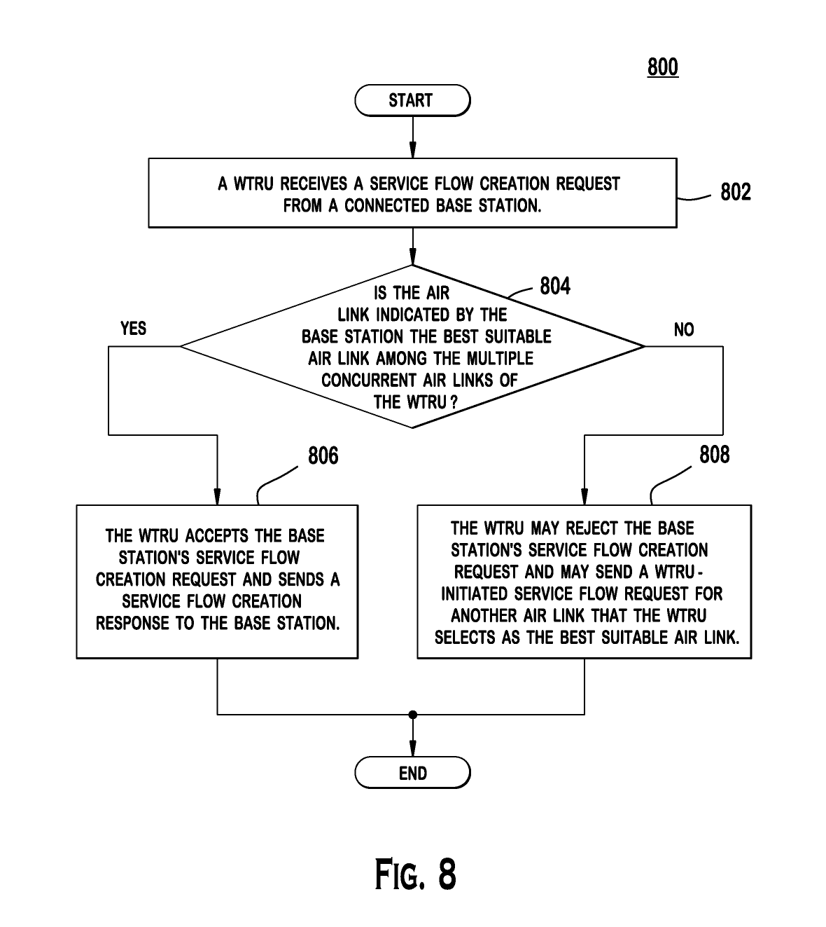

FIG. 8 is a flow diagram of an example process 800 of base station-initiated service flow creation in accordance with one embodiment. In the case of base station-initiated service flow, a WTRU receives a service flow creation request from a connected base station (802). The mapping of the service flow and the air link may be indicated by the base station. The WTRU determines whether or not the air link indicated by the base station is the best suitable air link among the multiple concurrent air links of the WTRU (804). The WTRU may accept or reject the request from the base station based on that determination. If it is determined that the indicated air link is the best air link, the WTRU accepts the base station's service flow creation request and sends a service flow creation response to the base station (806).

If it is determined that the indicated air link is not the best one, the WTRU may reject the base station's service flow creation request and may send a WTRU-initiated service flow request for another air link that the WTRU selects as the best suitable air link (808). Once the service flow is initialized, its mapping to the air link is established. All the data traffic and relevant control traffic of the service flow are transported on the mapped air link.

At any time during normal operation, a service flow may be mapped to one air link, (i.e., having one base station to service the service flow). In this way, the data path related network operations in base station and core network may remain unchanged.

The mapping between a service flow to an air link of the concurrent-MC WTRU may be changed, (i.e., the service flow may be remapped from one air link to another air link among the WTRU's concurrent air links). The service flow remapping may be triggered by either handover, load balancing actions, or the like, which will be explained in detail below.

A concurrent-MC WTRU may perform a handover while being connected to multiple base stations, (i.e., multiple air links), through its multiple concurrent radio carriers. The concurrent-MC WTRU handover is a process in which one of the serving air links of the concurrent-MC WTRU is withdrawn from its serving air link set, and the service flows mapped on the withdrawn air link are remapped to a different serving air link(s). The concurrent-MC WTRU handover process involves serving air link set update and service flow migration (i.e., service flow re-mapping).

The serving air link set update may be either (1) removing at least one air link from the serving air link set or (2) both removing at least one air link from the serving air link set and adding a new air link to the serving air link set. Each service flow on the removed air link is re-mapped to another air link in the air link set. All service flows may be re-mapped to the same air link or, alternatively, some service flows may be re-mapped to a different air link(s).

A new air link may be added to the serving air link set after the WTRU finishes the network entry procedure and brings the new air link up to the operational mode. The network entry of a concurrent-MC WTRU to an air link may be triggered by WTRU power-up, a handover decision with the target air link not in the serving set, or entering a service zone of the new base station, etc. A serving air link may be removed from the serving air link set after the WTRU is disconnected from the air link. Before the disconnection, all the service flows on the air link are re-mapped to other air link(s) that the WTRU is connected to. The disconnection of an air link may be triggered by a handover decision, changes of service demands at the WTRU, power down or system failures at the base station of the air link, etc.

The service flow to air link re-mapping, (i.e., service flow migration), is a process in which a service flow is moved from one air link to another of the concurrent-MC WTRU. During the service flow re-mapping process, the original air link is referred to as “serving air link” of the service flow and the destination air link is referred to as “target air link” of the service flow.

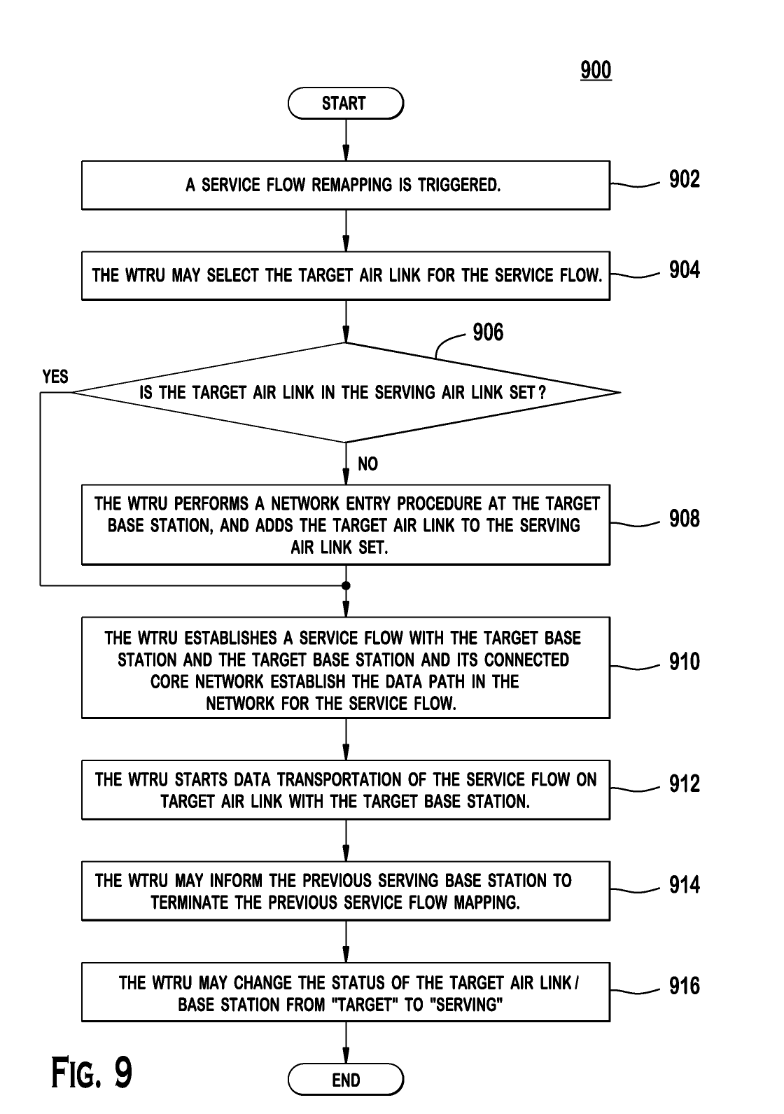

FIG. 9 is a flow diagram of an example process 900 of service flow remapping in accordance with one embodiment. A service flow remapping is triggered (902). The service flow remapping may be triggered by a handover or any other triggers, such as, load balancing among the multiple serving air links of the concurrent-MC WTRU. If the service flow remapping is triggered by the handover, it may be initiated by the serving base station of the service flow or the WTRU.

Once a service flow re-mapping process is triggered, the WTRU may select the target air link for the service flow (904). The selection may be performed with or without the assistance of the serving base station. The WTRU checks if the target air link is in the serving air link set (906). If not, the WTRU performs a network entry procedure at the target base station, and adds the target air link to the serving air link set (908). The WTRU establishes a service flow with the target base station and the target base station and its connected core network establish the data path in the network for the service flow (910). The WTRU starts data transportation of the service flow on target air link with the target base station (912). The WTRU may inform the previous serving base station to terminate the previous service flow mapping (914). The WTRU may change the status of the target air link/base station from “target” to “serving” (916). During the service flow re-mapping process, a service flow may be temporarily mapped onto multiple air links.

The support and use of multiple air links at a concurrent-MC WTRU may be transparent to the connected multiple base stations, (i.e., the base stations do not need to know the multiple connections of the WTRU to a plurality of base stations and each base station may operate without coordinating with other base stations to which the WTRU has a connection). Alternatively, a support may be provided by the base stations for the use of multiple air links at the concurrent-MC WTRU, (i.e., the base stations may coordinate each other for set-up and operation of the multiple air links with the multiple base stations). For example, the serving base station and the target base station may coordinate for the service flow re-mapping.

In order to add an air link to the serving air link set, the WTRU may obtain information about the new air link from the base station(s) in the current serving air link set.

The inter-base stations communication may also assist the power saving mechanisms of the concurrent-MC WTRU. For example, when an air link of the concurrent-MC WTRU goes to idle, the corresponding base station of the idle air link may communicate with other base station(s) of the active air links of the concurrent-MC WTRU for either paging information regarding downlink traffic pending, or for the subscriber's current location and/or status update.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method of wireless communication using a wireless transmit/receive unit (WTRU) capable of concurrently processing multiple radio carriers, the method comprising:
establishing a plurality of air links to a plurality of base stations simultaneously, the air links being established via a plurality of radio carriers;
mapping service flows to the air links; and
communicating simultaneously with the base stations via the air links for data transportation.

2. The method of claim 1 wherein the communication via the plurality of air links is transparent to the base stations.

3. The method of claim 1 wherein the multiple air links are controlled by a single common medium access control (MAC) entity.

4. The method of claim 1 wherein each of the multiple air links is controlled by a separate medium access control (MAC) entity.

5. The method of claim 1 wherein the WTRU receives one service flow from a macro-cell base station and receives another service flow from a micro-cell base station.

6. The method of claim 1 wherein the service flow is mapped to the air links based on service flow attributes and/or air link attributes.

7. The method of claim 1 further comprising:
performing a serving air link set update, the serving air link set is a set of serving air links that the WTRU is connected through the plurality of radio carriers, wherein at least one air link is removed from the serving air link set, or a new air link is added to the serving air link set.

8. The method of claim 1 further comprising:
performing a service flow remapping to remap the service flow to another air link.

9. The method of claim 8 further comprising:
selecting a target air link for the service flow remapping;
determining whether the target air link is in a serving air link set, the serving air link set is a set of serving air links with which the WTRU is connected through the plurality of radio carriers;
on a condition that the target air link is not in the serving air link set, performing a network entry procedure at a target base station, and adding the target air link to the serving air link set; and
establishing a service flow with the target base station.

10. The method of claim 9 wherein the service flow remapping is triggered by at least one of a handover, or load balancing among multiple serving air links of the WTRU.

11. A wireless transmit/receive unit (WTRU) comprising:
a plurality of radio frequency (RF) units for concurrently processing signals on a plurality of radio carriers; and
a processor configured to establish a plurality of air links to a plurality of base stations simultaneously, the air links being established via a plurality of radio carriers, map service flows to the air links, and communicate simultaneously with the base stations via the air links for data transportation.

12. The WTRU of claim 11 wherein the communication via the plurality of air links is transparent to the base stations.

13. The WTRU of claim 11 wherein the multiple air links are controlled by a single common medium access control (MAC) entity.

14. The WTRU of claim 11 wherein each of the multiple air links is controlled by a separate medium access control (MAC) entity.

15. The WTRU of claim 11 wherein the processor receives one service flow from a macro-cell base station and receives another service flow from a micro-cell base station.

16. The WTRU of claim 11 wherein the service flow is mapped to the air links based on service flow attributes and/or air link attributes.

17. The WTRU of claim 11 wherein the processor is configured to perform a serving air link set update, the serving air link set being a set of serving air links that the WTRU is connected through the plurality of radio carriers, wherein at least one air link is removed from the serving air link set, or a new air link is added to the serving air link set.

18. The WTRU of claim 11 wherein the processor is configured to perform a service flow remapping to remap the service flow to another air link.

19. The WTRU of claim 18 wherein the processor is configured to select a target air link for the service flow remapping, determine whether the target air link is in a serving air link set, the serving air link set being a set of serving air links with which the WTRU is connected through the plurality of radio carriers, on a condition that the target air link is not in the serving air link set, perform a network entry procedure at a target base station and add the target air link to the serving air link set, and establish a service flow with the target base station.

20. The WTRU of claim 19 wherein the service flow remapping is triggered by at least one of a handover, or load balancing among multiple serving air links of the WTRU.
